(19) United States
(12) Patent Application Publication
(10) Pub. No.: US 2014/0181243 A1
(43) Pub. Date: Jun. 26, 2014

(54) SERVER-BASED CONTENT TRACKING APPARATUS AND METHOD

(71) Applicant: ADSWIZZ S.A., Brussels (BE)

(72) Inventor: Bruno NIEUWENHUYS, Bucharest (RO)

(73) Assignee: ADSWIZZ S.A., Brussels (BE)

(21) Appl. No.: 13/723,373

(22) Filed: Dec. 21, 2012

(51) Int. Cl. H04L 29/06

(52) U.S. Cl. CPC H04L 29/06448
USPC 709/217

(57) ABSTRACT

A method for tracking digital content. The method can include receiving digital content data from a digital content provider; generating a client digital content data stream using the digital content data; sending the client digital content data stream to a client system; and sending a signal to a digital content tracking system when an event is triggered by at least one of (1) a status of the client digital content data stream, (2) a placeholder associated with the client digital content data stream, (3) an external event, and (4) metadata in the client digital content data stream. Accordingly, the method can be used to manage the complexity of the streaming data to a variety of client systems while simultaneously transmitting event-triggered signals to a variety of digital content tracking systems.

### FIELD OF THE INVENTION

This invention relates generally to the field of server-based digital content distribution and content tracking.

### BACKGROUND

Today, multimedia digital content is available for consumption on a multiplicity of Internet-enabled devices and applications. The sheer variety of devices and applications, however, has given rise to a wide variety of distribution formats, streams, and transport protocols for content providers to organize, arrange, and manage.

Distribution of digital content spans a wide variety of personal media consumption devices and applications, including Adobe-flash enabled websites, smartphone and tablet applications, and Internet-enabled set top boxes. These devices and applications may require different communication protocols and different video and audio streaming compression and codecs. Given the vast array of consumption devices and applications, distribution is a very complicated and technically challenging process.

For example, in today's digital content distribution systems, the client personal media consumption devices typically handle the collection and assembly of the digital content streams from both primary and secondary content providers. In other words, the end user's media player typically bears the responsibility for initiating the stream transfer, receiving the primary digital data (e.g., video or audio programming) from a primary content provider (e.g., network such as BBC in the case of network television or radio) and interspersing that primary content with secondary content (e.g., advertisements or other material) from a secondary content provider (e.g., digital advertisement provider). The synchronization of the process requires that content providers provide compatible digital data in compatible file formats over compatible data streams using compatible transport protocols. Hence, the variety of client devices and applications create compatibility challenges for content providers who are interested in delivering their content across a variety of client personal media consumption devices.

Further complicating the task of delivering digital content, content providers attempt to track user behavior and responses to the digital content. For example, advertising content providers can be interested in who, when, how, or where consumers are exposed to their content. To do so, advertising content providers frequently monitor and track user exposure and responses to different forms of digital advertising, such as video viewing time, and advertising click-throughs, through the use of third party tracking systems.

For illustration, FIG. 1 is a block diagram of the environment of a prior art system 100 that includes media consumer system 101, media server 102, advertisement server 103, and third party 104 in a networked arrangement. Typically, the media consumer system 101 receives an audio/video media stream from the media server 102, while also receiving advertising content with third party tracking information (such as a tracking pixel or link) from the advertisement server 103. Content providers today frequently insert a special tracking pixel or a link into their digital content stream as a “third party tracking tag.” A tracking pixel may be triggered on the client side by the consumer media system when playing the content. The burden and complexity of generating an aggregated media stream by inserting advertising content and third party tracking information into the audio/video media stream rests on the media consumer system 101. During playback of the content stream on the media consumer system 101, a tracking pixel or link may be triggered in the media consumer system 101, which sends a signal directly to the third party 104, which allows for tracking

The use of tracking pixels and links in prior art system 100, however, faces several difficulties. First, the media consumer systems may make use of a variety of distribution formats, streams, and transport protocols which complicates distribution for the media servers. Different formats, streams, and protocols may access the individual pixels of a digital content stream in individualized ways, leading to creating compatibility issues. Secondly, certain media consumer systems may be incompatible (i.e., lack the ability to process the tracking pixel or link) or unable to send the signal to the third party 104. Given the complexity arising from the proliferation of different media consumer devices/systems, there is a growing need to provide a consistent mechanism to monitor and track user behavior and content.

### SUMMARY OF INVENTION

According to one embodiment, a method of the invention includes receiving, at a content distribution system, digital content data from a digital content provider; generating, at the content distribution system, a client digital content stream, wherein the client digital content stream comprises at least the digital content data; sending the client digital content stream from the content distribution system to a client system; and sending a signal from the content distribution system to a tracking system when an event is triggered by at least one of a status of the client digital content stream, a placeholder associated with the client digital content stream, an external event, and metadata in the client digital content stream. The digital content data can be a digital content data stream and may be audio digital content data and/or video digital content data. Accordingly, this method can be used to manage client digital content streams from disparate content sources as well as send event-triggered signals to a tracking system that monitors the client digital content stream.

Another embodiment is a method of the invention includes receiving, at a content server, primary digital content data from a primary content provider; receiving, at a content server, a secondary digital content data from a secondary content provider; generating, at the content server, a client digital content stream, wherein the client digital content stream comprises at least the primary digital content data and the secondary digital content data; sending the client digital content stream from the content server to a client system; and sending a signal from the content server to a tracking system when an event is triggered by at least one of a status of the client digital content stream, a placeholder associated with the client digital content stream, an external event, and metadata in the client digital content stream.

Yet another embodiment of the invention is a computer-readable storage media embodying logic that is operable when executed to perform a series of steps. These steps include receiving, at a content distribution system, primary digital content data from a primary content provider; generating, at the content distribution system, a client digital content stream, wherein the client digital content stream comprises at least the primary digital content data; sending the client digital content stream from the content distribution system to a client system; and sending a signal from the content distribution system to a tracking system when an event is triggered by at least one of a status of the client digital content stream, a placeholder associated with the client digital content stream, an external event, and metadata in the client digital content stream.

### BRIEF DESCRIPTION OF THE DRAWINGS

The invention is illustrated in the figures of the accompanying drawings which are meant to be exemplary and not limiting, in which like references are intended to refer to like or corresponding part, and in which:

FIG. 1 is a block diagram showing the environment of a prior art system;

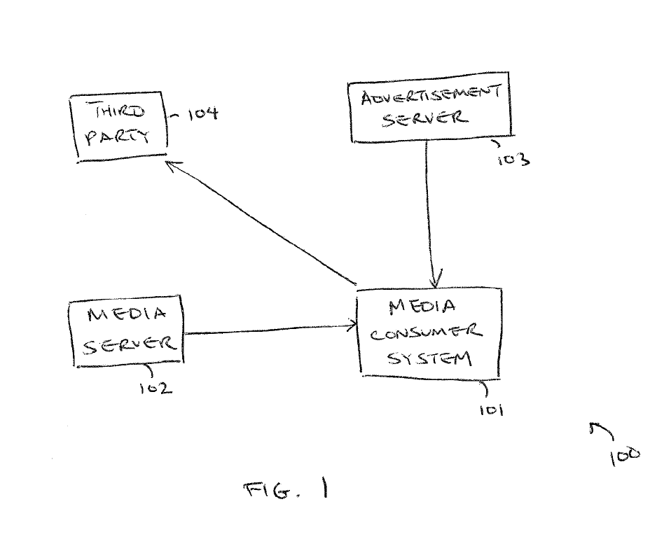

FIG. 2 is a block diagram showing the environment of one embodiment of the invention;

FIG. 3 is a flow diagram of a method accordance with certain embodiments of the disclosed subject matter;

FIG. 4 is a block diagram that shows greater detail of the content distribution system 201 shown in FIG. 2; and

FIG. 5 is a block diagram showing the environment of the invention in one embodiment.

### DETAILED DESCRIPTION

One challenge for digital content distribution and tracking rests in the complexity arising from distributing digital content streams to a myriad of client devices while simultaneously receiving tracking signals from those same client devices. For example, different client media consumption systems may use different protocols, data containers, digital codecs, and bandwidth requirements. When streaming video content, different devices may require video content of different resolutions, color depth and compression/codec formats. In addition, a third party can provide several links within a digital content stream if it wishes to be notified when 0%, 25%, 50%, 75%, and 100% of the digital content data has been played. At each stage, a link for each percentage can be provided. A single link may also contain multiple pieces of information. For example, a single link may contain both the name of a musical track played immediately before the tracked content as well as the length of time the user played back the tracked content. Multiple third parties may track a single piece of digital content, each providing their own links to provide themselves with the pertinent information.

Accordingly, the present invention can manage the complexity of the different data streams and signals at an intermediate level and reduce the complexity for the digital content providers and their respective tracking systems.

According to one aspect, the invention includes a method and apparatus that can receive digital content data, generate a personalized digital content stream, send the personalized digital content stream to a client system, and send a signal to a content tracking system when an event is triggered. In effect, the invention acts as a type of proxy server to the client providers, tracking systems, and client systems, such that the content providers send digital content data and the tracking systems receive tracking signals as if the client systems are connected via a proxy.

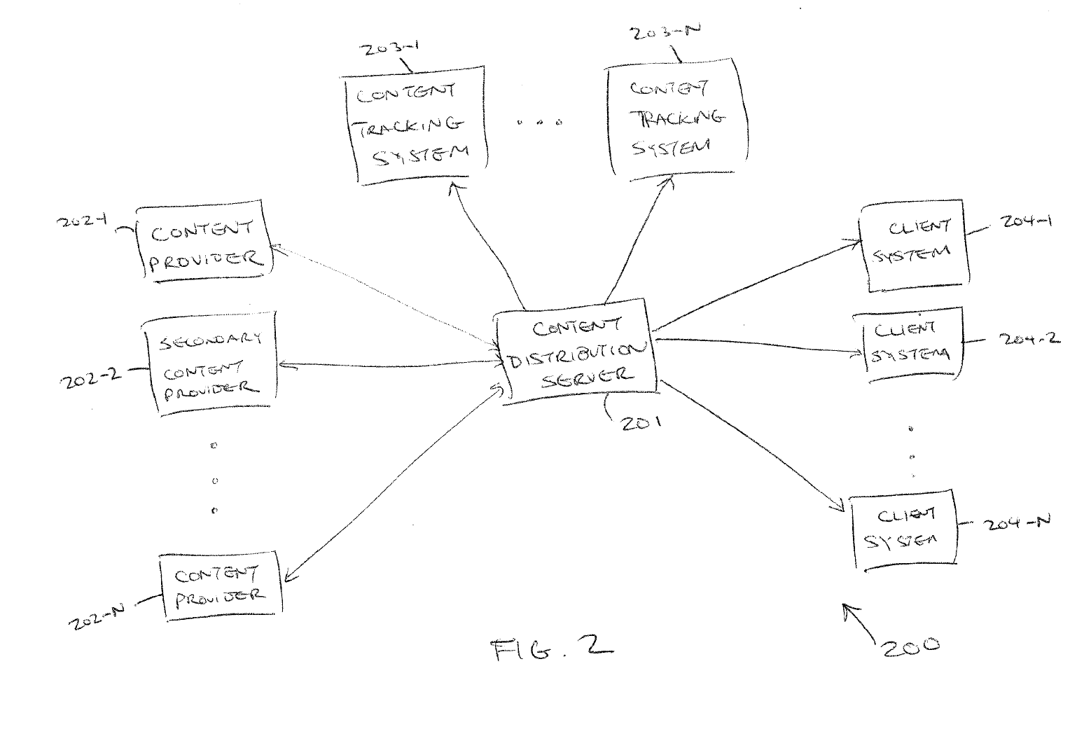

FIG. 2 illustrates a diagram of a networked electronic system in accordance with an embodiment of the invention. The networked system 200 can include a content distribution system 201, at least one content provider 202 (e.g., content provider 202-1, 202-2, . . . 202-N), at least one content tracking system 203 (e.g., content tracking system 203-1, 203-2, . . . 203-N), and at least one client system 204 (e.g., client 204-1, 204-2, . . . 204-N).

The content distribution system 201 sits at the center of the networked system 200, managing the connectivity to all of the other components in the network, such as content providers 202-1 through 202-N, content tracking systems 203-1 through 203-N, and the client systems 204-1 through 204-N. The content distribution system may be a computer system, comprising computer servers and a computer network for managing incoming digital content data from different content providers and transmitting digital content data streams to client systems and sending tracking signals to tracking systems. According to the invention, the content distribution system 201 can receive digital content data from digital content providers 201-1 through 202-N, generate and send client digital content data streams to client systems 204-1 through 204-N, and send tracking signals based on the sent client digital content data streams (and thus playback of the client digital content data stream) to tracking systems 203-1 through 203-N.

Digital content providers 202-1 through 202-N may each be a computer system, computer server, or computer network for a digital content producer such as a television network, a cable network, web video producer, or advertisers. For example, television networks such as FOX, ABC, CBS, ESPN and NBC regularly generate digital video content that may then be played over the Internet in digital consumption devices. Among cable networks, networks such as HBO, Showtime, AMC, and FX do the same. Similarly, many content providers make available digital audio content, including the BBC, PBS, and ESPN.

Tracking systems 203-1 through 203-N may each be a computer system, computer server, or a network of computer servers and systems, that receive signals that track the activity of the digital content streams transmitted by the content distribution system 201. Tracking systems 203-1 through 203-N may be affiliated with the content providers or managed by third parties for purposes of tracking consumption of digital content. For example, a third party may track the ratings/popularity for a particular webcast by tracking how much of the digital content data stream is played back on the client device, e.g., 25%, 50%, 75%, 100%. Alternatively, an advertising agency may track the exposure received by a particular audio/video advertisement, using a tracking signal triggered by playback.

The client systems 204-1 through 204-N may be any number of electronic devices capable of receiving and processing the client digital content data stream, such as a personal computer, a mobile computer, a mobile electronic device, and a personal electronic device. The client systems 204-1 through 204-N can be configured to playback the client digital content data stream through either an application, either a built-in application such as a browser or a customized application designed by a third party.

A communications network connects the content distribution system 201, the content providers 202-1 through 202-N, content tracking systems 203-1 through 203-N, and the client systems 204-1 through 204-N. The communication network can include the Internet, a cellular network, a telephone network, a computer network, a packet switching network, a line switching network, a local area network (LAN), a wide area network (WAN), a global area network, or any number of private networks that can be referred to as an Intranet. Such networks may be implemented with any number of hardware and software components, transmission media and network protocols. FIG. 2 shows the communications network as individual links; however, the network can include the multiple interconnected networks listed above.

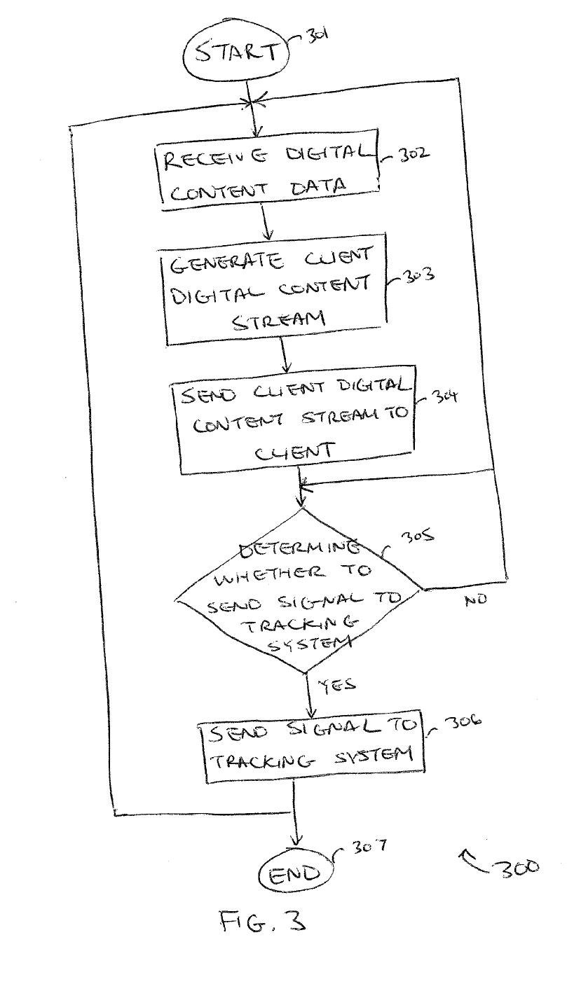

FIG. 3 is a flow chart that illustrates the operation of one embodiment of the invention. In FIG. 3, start block 301 can be initiated by a request for digital content data. The request may come as a particular set of instructions exposed through technology interfaces, such as software or hardware. The request may occur through a variety of mediums, such as a web interface, mobile interface, wire protocol, or shared data store such as a queue or similar construct. The request may occur through software or hardware, so it can be language independent, and may be initiated directly through a standardized interface or via a proprietary protocol from a software development kit or bundled set of libraries. The request may be provided directly by the content providers (e.g., 202-1 through 202-N from FIG. 2), the client systems (e.g., 204-1 through 204-N from FIG. 2), or through a third party, such as a hosting provider or software vendor. The request can be received by the content distribution system 201 (FIG. 2), which can precipitate the next blocks of the disclosed invention.

Next, at block 302, the content distribution system 201 (FIG. 2) can receive digital content data in order to generate a client digital content stream. The digital content data may be delivered from a digital content provider (e.g., 202-1 from FIG. 2), such the BBC or ESPN or any other source. In some embodiments, the digital content data may be audio digital content data (such as radio programming) or video digital content data (such as television or movie programming). In some embodiments, the digital content data may also be a digital content data stream, such as a flow of digital content data. Additionally, the digital content data may come in a variety of formats and codecs (e.g., MPEG, MP3, WAV, MIDI) over a variety of protocols and delivery systems (e.g., HTTP), depending on the capabilities of the content distribution system 201 (FIG. 2).

In some embodiments, digital content data may be delivered from multiple content providers; for example, a primary digital content provider (e.g., 202-1 from FIG. 2) may provide digital programming content as noted above, and a secondary digital content provider (e.g., 202-2 from FIG. 2) may be a digital advertising company that provides advertisements for broadcast with the digital content data from the content provider (e.g., 202-1 from FIG. 2). The secondary digital content data may also be a digital content data stream and may also be audio digital content data or video digital content data. Multiple secondary content providers (e.g., 202-2 through 203-N from FIG. 2) may deliver secondary digital content data to the content distribution system 201 (FIG. 2) for generation of the client digital content stream.

Next, at block 303, the content distribution system 201 (FIG. 2) can generate a client digital data content stream through the processing and manipulation of the digital content data from the digital content providers (e.g., 202-1 through 202-N from FIG. 2). In some embodiments, this may involve de-multiplexing, decoding, and re-encoding the respective digital content data into an appropriate format and codec for the client digital content stream, and ultimately, for the client system in some embodiments of the disclosed invention. For example, audio digital content data may be received as MP3 but need to be de-multiplexed, decoded, and re-encoded into WAV format for generation of the client digital content data stream for the client system (which may be expecting a data stream in WAV format). The end result is a client digital content data stream to be sent to the client system.

The generation of the client digital content data stream can involve the content distribution system 201 (FIG. 2) inserting secondary digital data content into the digital content data from the digital content provider (e.g., 202-1 from FIG. 2). Secondary digital content can be of a variety of types, including advertisements and tracking information. The content distribution system 201 (FIG. 2) can be configured to aggregate digital content data from both digital content providers to generate, for example, a digital broadcast of a sporting event interspersed with advertising information during commercial breaks and tracking tags to detect ratings and the viewing audience.

In order to aggregate the digital content data and insert the secondary digital content into the client digital content data stream, the content distribution system 201 (FIG. 2) can be configured to identify placeholders associated with the digital content data. In some embodiments, placeholders may be (1) a position within the digital content data, (2) one or more frames within the digital content data, (3) a time interval within the digital content data, and (4) an acoustic marker within the digital content data. Depending on the type of placeholder, advertisements may then be inserted into the digital content data based on a position within the stream, at a particular frame, at a particular time interval, or based on an acoustic marker (in the case of audio or video digital content data).

In some embodiments, insertion of the secondary digital content may require that the content distribution system 201 (FIG. 2) manage additional de-multiplexing, decoding, and re-encoding of the original digital content data stream in order to properly break and insert different (secondary) digital content data midstream. This may involve the calculation and generation of key frames at the location of placeholders (in the case of MPEG video) in order to properly halt the streaming of digital data from one source, stream digital data from another source, and then resume streaming digital data from the original source. The generated key frames may be used to bookend the inserted secondary digital data and allow the original digital content data stream to continue streaming to the client systems without error.

In certain embodiments, placeholders may also be used to trigger signals from the content distribution system 201 (FIG. 2) to a tracking system (e.g., 203-1 through 203-N from FIG. 2). For example, a signal may be sent to a tracking system (e.g., 203-1 from FIG. 2) at a particular location within the resulting client digital content data stream at the start, end, or specific point in the stream in order to help track a user's use of the stream. The particularized use of the stream may be then interpreted and used to direct specific advertisements or information to a particular user via secondary digital content data streams.

Next, at block 304, the content distribution system 201 (FIG. 2) can transmit the client digital content data stream to the client system. Similar to the initial request at starting block 101, the transmission of the client digital content data stream may come through a variety of technology interfaces, such as software or hardware. The request may occur through a variety of mediums, such as a web interface, mobile interface, wire protocol, or shared data store such as a queue or similar construct. Because the transmission may occur through software or hardware, it can be protocol independent, and it may be through a standardized interface or via a proprietary interface provided in a software development kit or bundled set of libraries.

In some embodiments, the content distribution system 201 (FIG. 2) may send buffered portions of the client digital content data stream, while simultaneously generating subsequent buffered portions of the client digital content stream from data digital content and secondary digital content data currently being received. In some embodiments, thus, receiving digital content data, generating the client digital content data stream, and sending the client digital content data stream may be coterminous and continuous.

Next, at block 305, the content distribution system 201 (FIG. 2) may check the client digital content data stream to determine whether to send a signal to a tracking system (e.g., 203-1 through 203-N from FIG. 2) at block 306. In some embodiments, the tracking system (e.g., 203-1 from FIG. 2) may also be the content provider (e.g., 202-1 from FIG. 2), a secondary content provider (e.g., 202-2 from FIG. 2), or a third party. For example, the tracking system (e.g., 203-1 from FIG. 2) may be in place to determine whether the user of the client system (e.g., 204-1 from FIG. 2) viewed a particular advertisement, portion of the client digital content data stream, or if the user closed the client digital content data stream. Based on the tracking results, a secondary digital content provider (e.g., 202-2 from FIG. 2) can track the exposure and effectiveness of content (such as a particular advertisement) that was distributed as secondary digital content data.

The content distribution system 201 (FIG. 2) can send the signal when an event is triggered by (1) the status of the client digital content data stream, (2) the placeholder associated with the client digital content data stream, (3) an external event, and (4) metadata in the client digital content data stream. An “event” is any action that a party would like to track. For example, a party may want to track when a user has played back 25%, 50%, 75% and 100% of the digital content data stream.

The events triggering may be flexibly used to track all manner of playback scenarios. For example, playback progress may be detected using the status of the client digital content data stream. In some embodiments, the content distribution system 201 (FIG. 2) may send a signal to the tracking system (e.g., 203-1 from FIG. 2) when a client digital content data stream is initiated or terminated. In some embodiments, a signal may be sent when the client system (e.g., 204-1 from FIG. 2) disconnects from the content distribution system, also resulting in a digital content data stream termination. Using those signals, the digital content provider can determine, for example, ratings, popularity and success of the digital content data. As discussed earlier, signals based on placeholders associated with the client digital content data stream may operate in a similar way. Signals based on metadata may be more flexible, containing background information relating to the content of the data stream, such as the title of the data stream, the size of the data stream, the creation date of the data stream, and the length of the data stream.

In contrast, events triggered by placeholders inserted into the digital content data stream are generally keyed to playback progress. For example, a placeholder may be inserted at the 25%, 50%, 75%, or 100% mark to trigger tracking signals or the insertion of secondary digital content data, such as advertising data.

Signals from the content distribution system 201 (FIG. 2) based on external events can provide additional information to the tracking systems. In some embodiments, the handling of external events may be facilitated by the receiving of data relating to the geographic information of the client system (e.g., 204-1 from FIG. 2). In some embodiments, the external events may be related to a newsworthy event associated with the geographic location of the client system (e.g., 204-1 from FIG. 2), such as inclement weather, a natural disaster, or even the commission of a crime. The tracking system may inform content providers, particularly secondary content providers (e.g., 202-2 from FIG. 2), to send appropriate information to the content distribution system 201 (FIG. 2), such as public service announcements or relevant advertising materials. Relatedly, the external event may also relate to the results of a sporting event in some embodiments. In that particular circumstance, the appropriate signal may trigger secondary content providers (e.g., 202-2 through 202-N from FIG. 2) to distribute advertisements relevant to a particular team, tournament or player.

If the client digital content data stream, or current portion thereof, does not trigger an event, the content distribution system 201 (FIG. 2) may continue to transmit the client digital content data stream, continue to receive digital content data from digital content providers (e.g., 202-1 through 202-N from FIG. 2), and continue to monitor transmitted portions of the client digital data stream for a triggered event.

The transmission can be configured to terminate in block 307 upon completion of the transmission of the client digital content data stream from the content distribution server 201 (FIG. 2) to the content to the client system (e.g., 204-1 from FIG. 2).

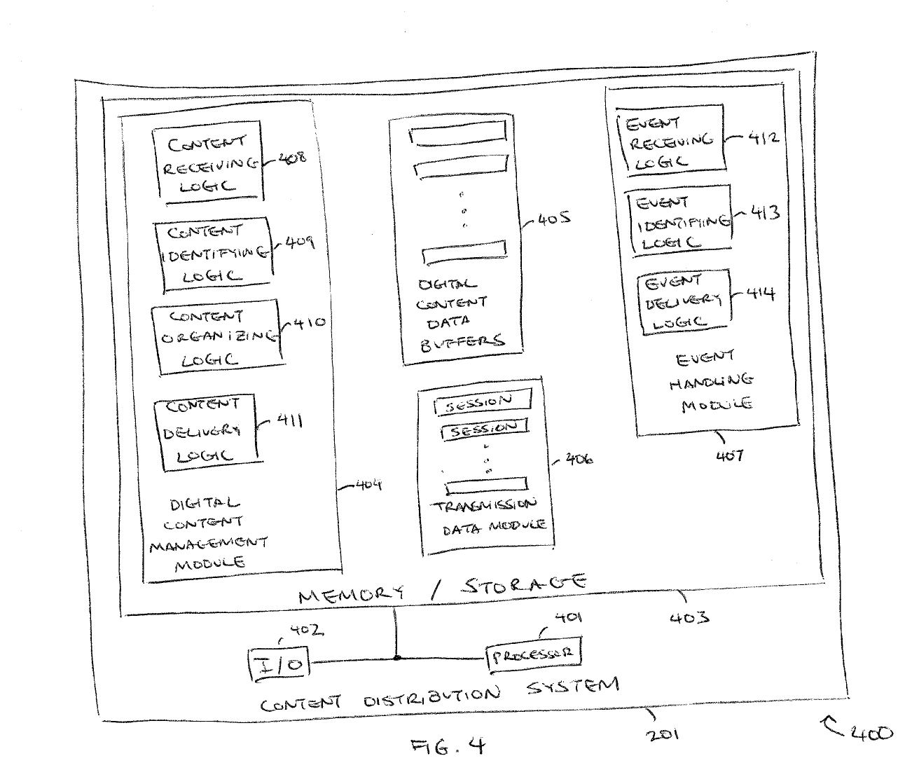

FIG. 4 is a block diagram that shows greater detail of the content distribution system 201 from FIG. 2. At a high level, the content distribution system 201 comprises a processor 401, an input/output component 402, and a memory/storage module 403 that comprises the logic modules for operation of the system as a whole. Within the memory storage module are several necessary modules, including the digital content management module 404, the digital content data buffers 405, the transmission data module 406, and the event handling module 407.

Processor 401 can be configured as a central processing unit or application processing unit in the content distribution system 201 from FIG. 2. Processor 401 might also be implemented in hardware using an application specific integrated circuit (ASIC), programmable logic array (PLA), field programmable gate array (FPGA), or any other integrated circuit or circuit structure that can perform the functionality of the content distribution system 201 from FIG. 2.

Input/Output component 402 may comprise a specialized combination of circuitry (such as ports, interfaces, wireless antennas) and software (such as drivers) capable of handling the receiving of digital content data from content providers (e.g., 202-1 through 202-N from FIG. 2 during block 302 of FIG. 3), sending signals to tracking systems (e.g., 203-1 through 203-N from FIG. 3 during block 304 of FIG. 3), and sending digital content data streams to client systems (e.g., 204-1 through 204-N during block 306 of FIG. 3).

Memory/storage module 403 can be cache memory, flash memory, a magnetic disk drive, an optical drive, a programmable read-only memory (PROM), a read-only memory (ROM), or any other memory or combination of memories. The memory 403, therefore, can be a non-transitory computer readable medium of a variety of types known to those skilled in the art.

Within memory/storage module 403, the digital content management module 404 comprises logic modules for the operation of the content distribution system. When executed, the logic and instructions on the memory 403 perform the operations described herein. The content receiving logic module 408 can be configured to handle the incoming data streams (e.g., during block 302 of FIG. 3). It can be configured to identify available storage locations within the digital content data buffers 405 to store the incoming digital content data. The content receiving logic module 408 can also be configured to communicate the location of the digital content data to the content identifying logic module 409, which manages the available data buffering to ensure that all received digital content data is received, stored, and retrievable for the generation of the client digital content data stream during block 303 of FIG. 3.

The content organizing logic module 410 can be configured to arrange the received digital content data into the client digital content data streams. In some embodiments, this can involve using identified placeholders to insert secondary digital content data (such as advertisements) into the primary digital content data (audio or video programming). The type of placeholders will determine how the placeholders are interpreted. If the placeholders indicate a position within the digital content data, such as a frame or time interval, the content organizing logic 410 can be configured to calculate the appropriate frame and interval to insert the appropriate secondary digital content data. If the placeholder indicates an acoustic marker, the content organizing logic 410 can be configured to acoustically analyze the digital content data to calculate the appropriate frame or time interval to insert the secondary digital content data.

The content delivery logic module 411 can be configured to prepare the assembled client digital content data stream for delivery to the client system. From the transmission data module 406, the content delivery logic 411 can determine the stream attributes expected by the client system, such the appropriate buffer size, file format and content codec. Depending on the state of the client digital content data stream, the content delivery logic may de-multiplex, de-code and re-encode the client digital content data stream prior to transmission to the client system. The resulting client digital content data stream may be stored in digital content data buffers 405 for transmission during block 304 of FIG. 3.

In addition to providing the stream attributes to the content delivery logic 411, the transmission data module 406 manages and maintains information relating to the client system (e.g., 204-1 from FIG. 2), connection to the client system, and the digital content data stream in separate session data profiles. Using the session data stored the transmission data module 306, the Input/Output component 402 transmits the data stream to the client systems.

The event handling logic 407 can be configured to manage the transmission of signals to the tracking systems (e.g., 203-1 through 203-N from FIG. 2 during block 305 of FIG. 3). Within the event handling logic module 407, the event receiving logic module 412 can be configured to receive signals related to the geographic location of client systems (e.g., 204-1 through 204-N from FIG. 2), as well as any event signals from them. The event identifying logic module 413 can be configured to use information about the client systems (e.g., 204-1 through 204-N from FIG. 2) from transmission data module 406 to determine whether events have been triggered that necessitate transmitting a signal to the appropriate tracking system (e.g., 203-1 from FIG. 3). If an event necessitates a signal, the event delivery logic module 414 can be configured to format and package the appropriate signal to be sent to the appropriate tracking system for block 306 from FIG. 3.

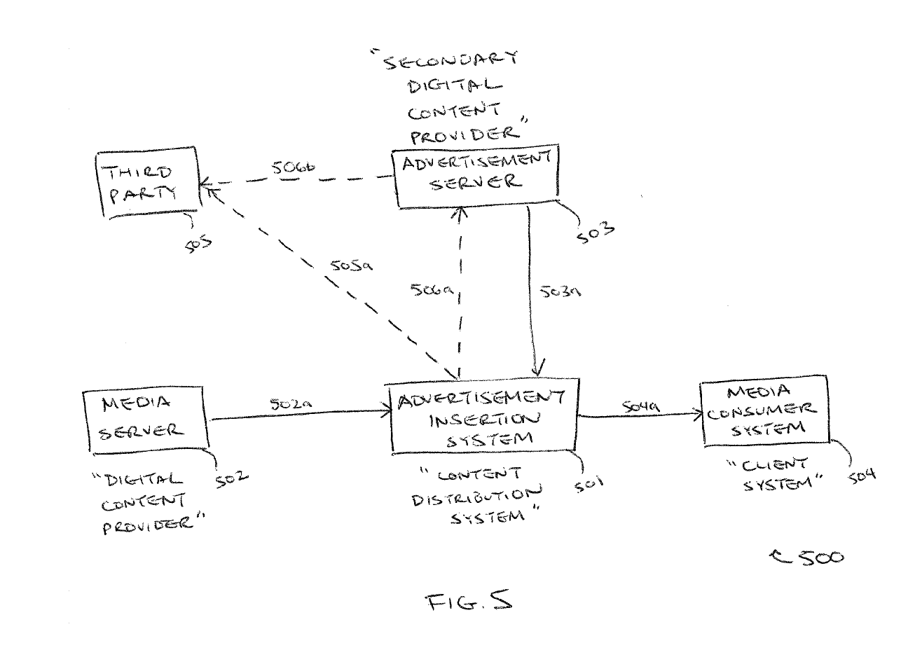

FIG. 5 illustrates a diagram of a networked electronic system in accordance with one specific embodiment of the invention. The networked system 500 can include an advertisement insertion system 501, media server 502, advertisement server 503, media consumer system 504, and third party 505.

Similar to the content distribution system 201 from FIG. 2, the advertisement insertion system 501 sits at the center of the networked system 500, connecting media server 502, advertisement server 503, media consumer system 504, and third party 505. The advertisement insertion system 501 may be a computer system, comprising computer servers and a computer network capable of receiving media streams from the media server 502, receiving digital advertisements from the advertisement server 503, and inserting those advertisements into the media streams. FIG. 5 shows the reception of media from the media server 502 as step 502a, and it shows the reception of digital advertisements from the advertisement server 503 as step 503a. The order of these two steps does not matter.

After inserting the advertisements into the media stream, the advertisement insertion system can be configured to transmit the media streams to media consumer system 504. This is shown as step 504a in FIG. 5. As the media stream is transmitted, the advertisement insertion system 501 may report the transmission of a particular advertisement to third party 505. This is shown in step 505a. Alternatively, the advertisement insertion system 501 may report to the advertisement server 503 when a particular advertisement is transmitted to the media consumer system, and the advertisement server 503 may then report this to the third party 505. This is shown as steps 506a and 506b.

The media server 502 may each be a computer system, computer server, or computer network for a digital content producer such as a television network, a cable network, web video producer, or Internet radio station. Upon request, media server 502 may send a media stream containing digital content data to the advertisement insertion system 501. The media stream can be configured to include placeholders for the advertisement insertion system 501 to insert advertisements from the advertisement server 503.

The advertisement server 503 may be a computer system, computer server, or computer network for a digital advertisement distributor or producer. The advertisement server 503 can be configured to send advertisements to the advertisement insertion system 501 for insertion into the media stream that ultimately is sent to the media consumer system 504.

The advertisement server 503 may also be configured to receive electronic reporting signals from the advertisement insertion system 501 when a particular advertisement is transmitted to the media consumer system 504 in a media stream. When the reporting signal is received, the advertisement server 503 can be configured to relay the information to third party 505.

The media consumer system 504 may be any number of electronic devices capable of receiving and processing the client digital content data stream, such as a personal computer, a mobile computer, a mobile electronic device, and a personal electronic device. The media consumer system 504 can be configured to playback the media stream (with advertisements) through either an application, either a built-in application such as a browser or a customized application designed by a third party.

The third party 505 may configured to receive electronic reporting signals that a particular advertisement has been delivered to the media consumer system 505 either from the advertisement insertion server 501 or advertisement server 503. In both cases, the third party 505 can be configured to tabulate and collect the tracking information for use in data collection by content providers, producers, and distributors.

Thus, improved techniques for managing digital content data from digital content providers and transmitting tracking signals to external tracking systems have been described. The use of the method and apparatus can, for example, allow content providers to transmit digital content data and receive tracking signals without having to manage the complexities arising from distributing that data to a variety of client systems. The method and apparatus can do this, in part, by sending a tracking signal from the content distribution system to the tracking system.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method comprising:
(a) receiving, at a content distribution system, digital content data from a digital content provider;
(b) generating, at the content distribution system, a client digital content data stream, wherein the client digital content data stream comprises at least the digital content data;
(c) sending the client digital content data stream from the content distribution system to a client system; and
(d) sending a signal from the content distribution system to a tracking system when an event is triggered by at least one of (1) a status of the client digital content data stream, (2) a placeholder associated with the client digital content data stream, (3) an external event, and (4) metadata in the client digital content data stream.

2. The method of claim 1, wherein the digital content data is a digital content data stream.

3. The method of claim 1, wherein the digital content data comprises at least one of (1) audio digital content data and (2) video digital content data.

4. The method of claim 1, further comprising identifying a location of the placeholder associated with the client digital content data stream.

5. The method of claim 4, wherein the location of the placeholder associated with the digital content data is at least one of (1) a position within the digital content data, (2) one or more frames within the digital content data, (3) a time interval within the digital content data, and (4) an acoustic marker within the digital content data.

6. The method of claim 1, wherein the client system is at least one of a personal computer, a mobile computer, a mobile electronic device, and a personal electronic device.

7. The method of claim 1, wherein the external event is related to a newsworthy event associated with the geographic location of the client system, and wherein the external event relates to at least one of weather, an emergency broadcast message, and a sporting event.

8. The method of claim 1, wherein the event is associated with the initiation of the client digital content data stream.

9. The method of claim 1, wherein the event is associated with the termination of the client digital content data stream.

10. The method of claim 9, wherein the event is associated with the disconnection of the client system.

11. The method of claim 1, further comprising receiving data relating to the geographic location of the client system.

12. The method of claim 1, further comprising receiving, at the content distribution system, secondary digital content data from a secondary content provider.

13. The method of claim 12, wherein the client digital content data stream further comprises the secondary digital content data.

14. The method of claim 12, wherein the secondary digital content data is a digital content data stream.

15. The method of claim 12, wherein the secondary digital content data is at least one of advertisement information, weather information, and information associated with the geographic location of the client system.

16. The method of claim 12, wherein generating the client digital content data stream includes inserting the secondary digital content data into the digital content data in accordance with the location of the placeholder.

17. A method comprising:
(a) receiving, at a content server, primary digital content data from a primary content provider;
(b) receiving, at a content server, a secondary digital content data from a secondary content provider;
(c) generating, at the content server, a client digital content data stream, wherein the client digital content data stream comprises at least the primary digital content data and the secondary digital content data;
(d) sending the client digital content data stream from the content server to a client system; and
(e) sending a signal from the content server to a tracking system when an event is triggered by at least one of (1) a status of the client digital content data stream, (2) a placeholder associated with the client digital content data stream, (3) an external event, and (4) metadata in the client digital content data stream.

18. The method of claim 17, wherein the primary digital content data is a digital content data stream.

19. The method of claim 17, wherein the primary digital content data comprises at least one of (1) audio digital content data and (2) video digital content data.

20. The method of claim 17, wherein the client system is at least one of a personal computer, a mobile computer, a mobile electronic device, and a personal electronic device.

21. The method of claim 17, further comprising identifying a location of the placeholder associated with the primary digital content data.

22. The method of claim 21, wherein the location of the placeholder associated with the primary digital content data is at least one of (1) a position within the primary digital content data, (2) one or more frames within the primary digital content data, (3) a time interval within the primary digital content data, and (4) an acoustic marker within the primary digital content data.

23. A non-transitory computer readable medium having executable instructions that are operable, when executed, to cause an apparatus to:
(a) receive, at a content distribution system, primary digital content data from a primary content provider;
(b) generate, at the content distribution system, a client digital content data stream, wherein the client digital content data stream comprises at least the primary digital content data;
(c) send the client digital content data stream from the content distribution system to a client system; and
(d) send a signal from the content distribution system to a tracking system when an event is triggered by at least one of (1) a status of the client digital content data stream, (2) a placeholder associated with the client digital content data stream, (3) an external event, and (4) metadata in the client digital content data stream.

24. The non-transitory computer readable medium of claim 23, wherein the primary digital content data is a digital content data stream.

25. The non-transitory computer readable medium of claim 23, wherein the primary digital content data comprises at least one of (1) audio digital content data and (2) video digital content data.

26. The non-transitory computer readable medium of claim 23, wherein the client system is at least one of a personal computer, a mobile computer, a mobile electronic device, and a personal electronic device.

27. The non-transitory computer readable medium of claim 23, wherein the executable instructions are further operable to cause the apparatus to identify a location of the placeholder associated with the primary digital content data.

28. The non-transitory computer readable medium of claim 27, wherein the location of the placeholder associated with the primary digital content data is at least one of (1) a position within the primary digital content data, (2) one or more frames within the primary digital content data, (3) a time interval within the primary digital content data, and (4) an acoustic marker within the primary digital content data.
